(19) United States
(12) Patent Application Publication
(10) Pub. No.: US 2011/0187114 A1
(43) Pub. Date: Aug. 4, 2011

(54) Wind driven turbine

(76) Inventor: Bert Socolove, Howell, NJ (US)

(21) Appl. No.: 12/658,238

(22) Filed: Feb. 4, 2010

(51) Int. Cl. F03D 9/00; F03D 3/04

(52) U.S. Cl. 290/55; 415/208.1

(57) ABSTRACT

A wind turbine has a housing with an airflow inlet and an airflow outlet. Enclosed within the housing is a rotor unit having a horizontally oriented shaft and elongated double-sided blades. Each blade has two concave outer surfaces for creating optimum lift regardless of wind flow direction. Secured within the housing and over and under the blades are shroud members which assist in creating a Venturi effect, that is rapid air flow within the housing, further increasing the efficiency of the wind turbine. Louvers are provided on the sides of the housing to optimally direct air flow into, through, and out of the housing.

### BACKGROUND OF THE INVENTION

A variety of wind driven turbine designs have been proposed and some have been manufactured and put into use. The earliest wind turbines were drag type designs or ones where the turbine blades were pushed by the wind, but created resistance when advanced into the wind. The rotors of such designs rotated slowly and the respective blades slowed the rotor as it advanced into the wind.

More recently, wind turbine designs are configured to utilize lift instead of drag. While there are many such wind turbine designs, most commercial wind turbines are three blade horizontal axis turbines. The trend is towards larger turbines capable of producing megawatts of electrical power. However, these turbines are expensive and require sophisticated engineering and power distribution systems.

Traditional wind powered turbine systems, while they do not rely on fossil fuels, still carry with them a number of significant disadvantages including the high initial capital cost and continuing maintenance expenses, especially of large wind turbines. Additional expense is incurred in the need to install electrical transmission lines from the source of wind generation to the location of power use. Running electrical lines also entails obtaining consent and permits from the local municipalities concerned with resource management. Moreover, large turbines can adversely effect the visual amenity of landscapes. Many towns and cities with strict zoning restrictions forbid horizontal wind turbines since they are viewed as eyesores.

Other disadvantages of existing horizontal wind turbines include their being considered hazards when turbine blades fling ice in bad weather. Sunlight shining on rotating blades also sometimes creates an effect such as flicker vertigo, which can cause an adverse psychological reaction on people and livestock.

Notwithstanding the above problems and disadvantages of existing wind turbines, the main focus for reducing reliance on fossil fuels using wind energy has been in the creation of wind farms. These wind farms normally have a number of large turbines on vertical towers, rotating about a horizontal axis to supply electricity to users when the rotor blades are turned towards the prevailing wind. Various designs for vertical axis turbines have also been proposed. These turbines have vertically oriented elongated blades rotating about a vertical axis. Nonetheless, the wind turbines in these systems are also subject to the various problems and disadvantages previously described.

### SUMMARY OF THE INVENTION

It is thus the object of the present invention to overcome the disadvantages and limitations of existing wind turbines.

It is thus an object of the present invention to provide a wind turbine which is simple and quiet in operation having relatively few moving parts.

It is another object of the present invention to provide a wind turbine capable of operating over a wide range of wind speeds and wind directions.

It is a further object of the present invention to provide a wind turbine which is economical in generating electrical power.

It is still another object of the present invention to provide a wind turbine which may be used for generating electricity for small and large facilities.

It is a further object of the present invention to provide a wind turbine which is easily mounted for use in residential locations.

It is still another object of the present invention to provide a wind turbine which consists of a modular design allowing for the use of individual units to be mounted end to end.

It is another object of the present invention to provide a wind turbine which uses prevailing ambient wind flow in a most efficient manner, to optimize blade lift and minimize drag.

These and other objects are accomplished by the present invention, a wind turbine comprising a housing having an airflow inlet and an airflow outlet. Enclosed within the housing is a rotor unit having a horizontally oriented shaft and elongated double-sided blades. Each blade has two concave outer surfaces for creating optimum lift regardless of wind flow direction. Secured within the housing and over and under the blades are shroud members which assist in creating Venturi effect, that is rapid air flow within the housing, further increasing the efficiency of the wind turbine. Louvers are provided on the sides of the housing to optimally direct air flow into, through, and out of the housing.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the wind turbine of the present invention showing its housing and internal components.

FIG. 2 is a cross-sectional view of the wind turbine of the present invention.

FIG. 3 is an isometric view of the wind turbine of the present invention with the addition of louvers, vertical fins and housing support roof bracket.

FIG. 4 is a side view of the blade and shaft arrangement of the wind turbine of the present invention.

FIG. 5 is an end view of a representative turbine blade of the present invention.

FIGS. 6a and 6b are power diagrams depicting the operation of the wind turbine of the present invention.

FIG. 7 is an isometric view of the wind turbine of the present invention mounted on the roof of a residential structure.

### DETAILED DESCRIPTION OF THE INVENTION

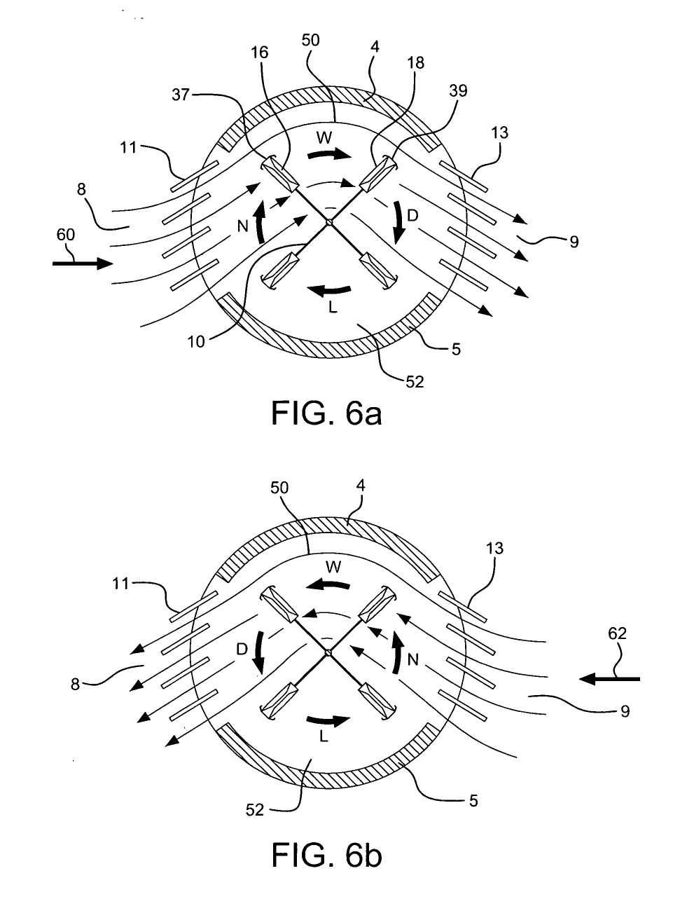

Wind turbine 1 of the present invention comprises housing 2 with top shroud 4, bottom shroud 5, and end sections 6 and 7. Air flow inlet 8 and outlet 9 are located at the front and rear sides of housing 2. Air flow inlet 8 becomes the outlet, and air flow outlet 9 becomes the inlet, depending on wind direction. (See FIGS. 6a and 6b). Front and rear sides of housing 2 also comprise horizontally extending louver sets 11 and 13, each set comprising a plurality of louvers. The louvers are angularly adjustable, as will be discussed in additional detail hereinafter.

Enclosed within housing 2 is rotor unit 10 comprising horizontally oriented rotor shaft 12 having horizontal axis 14. Horizontally oriented elongated blades 16, 18, 20 and 22 are connected to shaft 12 via connecting rods 17, 19, 21, and 23, such that elongated gaps or spaces are left between each of the blades and the shaft. See, for example, 24 in FIG. 4, with regard to blade 22 and shaft 12. These spaces prevent the blockage of air which can inhibit rotation of rotor unit 10 at low wind speeds.

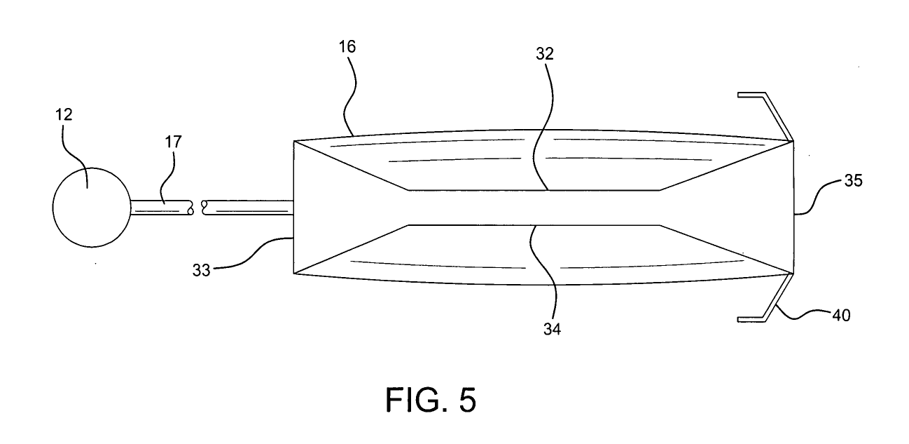

FIG. 5 shows a representative turbine blade. Turbine blade 16 comprises double-sided concave surfaces 32 and 34, interior edge 33 and outer edge 35. Blade tip end plate 40 extends down from the end of outer edge 35 to prevent air flow at the end of blade 16 from spilling over. Each blade in rotor unit 10 is thus configured to be productively utilized when rotated both in the clockwise and counterclockwise directions.

Rotor unit 10 is supported within housing 2 at one end by a connection between shaft 12 and bearing 42 secured to side section 7. The other end of shaft 12 is connected to electrical generator, pump or other electrical motive device 44 via a suitable transmission. Rotor unit 10 will rotate in both the clockwise and counterclockwise, depending on wind direction.

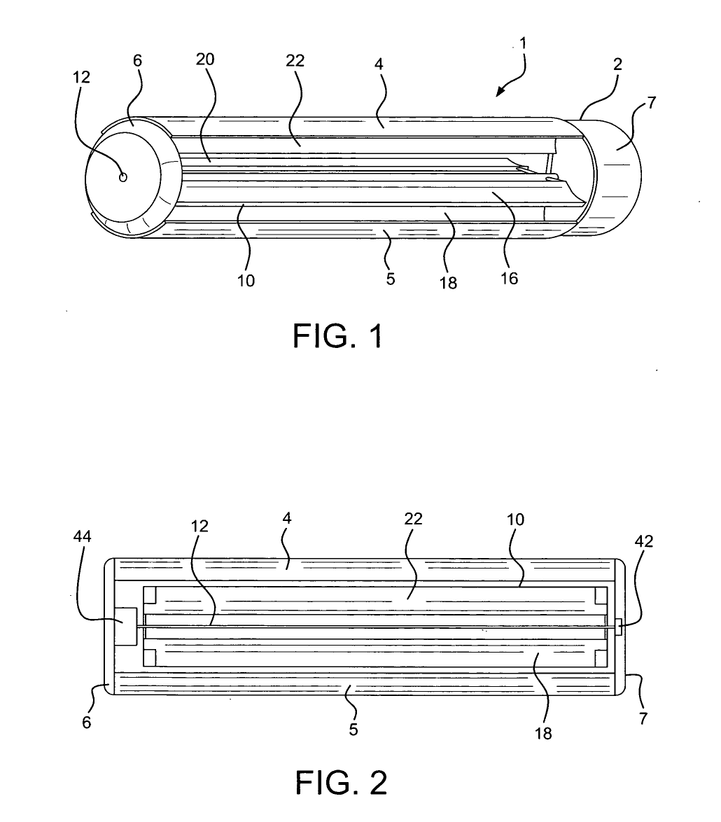

Upper shroud 4 and lower shroud 5 are curved in configuration and are secured to side sections 6 and 7 of housing 2. As best seen in FIGS. 1, 3, 6a and 6b, upper shroud 4 partially encircles the interior, upper region of housing 2 and is positioned such that an elongated open area 50 is created between the blades of rotor unit 10 and the upper shroud when these blades are below the upper shroud. Lower shroud 5 partially encircles the interior, lower region of housing 2 and is positioned such that an elongated open area 52 is created between the blades of rotor unit 10 and the lower shroud when these blades are above the lower shroud.

The operation of the wind turbine of the present invention is described by reference to FIGS. 6a and 6b. Wind flow 60 is directed through louver set 11 and inlet 8 at the front side of housing 2 towards rotor unit 10. The rotor unit has a windward power quarter W, wherein its blades are predominantly driven by lift forces; a drag power quarter D, wherein blades are predominantly pushed by the incident wind flow; a leeward power quarter L, wherein blades are again predominantly driven by lift forces; and a non-power quarter N, wherein blades predominantly produce drag. Air flow exits housing 2 through outlet 9 and louver set 13.

Significantly, additional upwards lift is created by the flow in open area 50 between upper shroud 4 and the outer edges of the blades, e.g. outer edges 35 of blade 16, and outer edge 39 of blade 18. This additional lift is seen, albeit to a lesser extent, between the outer edges of the blades and lower shroud 5, in open area 52. Airflow through open areas 50 and 52 creates a Venturi effect in these locations which materially enhances power generation and reduces drag within housing 2. It can be appreciated that when wind flow 62 comes from the opposite direction, rotor unit 10 will rotate in a counterclockwise direction, but will experience the same power, drag power, leeward power and non-power quarters, and the enhanced power generation of the Venturi effect between blades and upper and lower shrouds.

Louver sets 11 and 13 are provided to shield blades from direct air flow and redirect the flow at optimal angles into the retreating blades of rotor unit 10 and towards upper shroud 4 and lower shroud 5. The louver sets also concentrate air flow towards the blades which rotate away from the louver sets to assist in maintaining non-turbulent air flow. Trailing louver sets, that is those which receive the discharged air flow from rotor unit 10, also contribute to maintaining a non-turbulent flow of existing air from housing 2. Louver sets 11 and 13 are pivotable, typically between a range of approximately 30° to 60° relative to incident air flow. This allows incident air flow to be optimally directed as wind speed changes.

The optimal angle of each louver in louver sets 11 and 13 will be different from its neighboring louver. Each will have a progressively more horizontal angle, such that the bottommost louver starts at about 45° and progresses to the top louver which is almost 0° degrees to the horizontal. All louvers of louver sets 11 and 13 are designed to rotate to the same profile as upper shroud 4 and lower shroud 5, so they can effectively form a part of the front and rear sides of housing 2, and thus provide protection from bad weather and the inner components of wind turbine 1.

Control of louver sets 11 and 13 may be either by electronic or mechanical means. Electronic sensors may sense the direction and speed of the incident air flow and supply this information to a controller, which regulates the angle of the louvers via electromechanical means. Alternatively, an air flow surface may be connected to the louvers via a suitable mechanical linkage to control their angle.

As previously described, rotor unit 10 is connected to a generator or other motive device 44. Generators having a high number of poles may be directly driven to simplify the design and reduce frictional losses. Generators employing permanent magnetic rotors or stators are particularly suitable. Where wind turbine 1 drives an electrical generator, such a unit may be connected to the local electrical supply network so that local generation may be injected into the grid when surplus power is generated. Alternatively, the generator may be connected to an optional power supply.

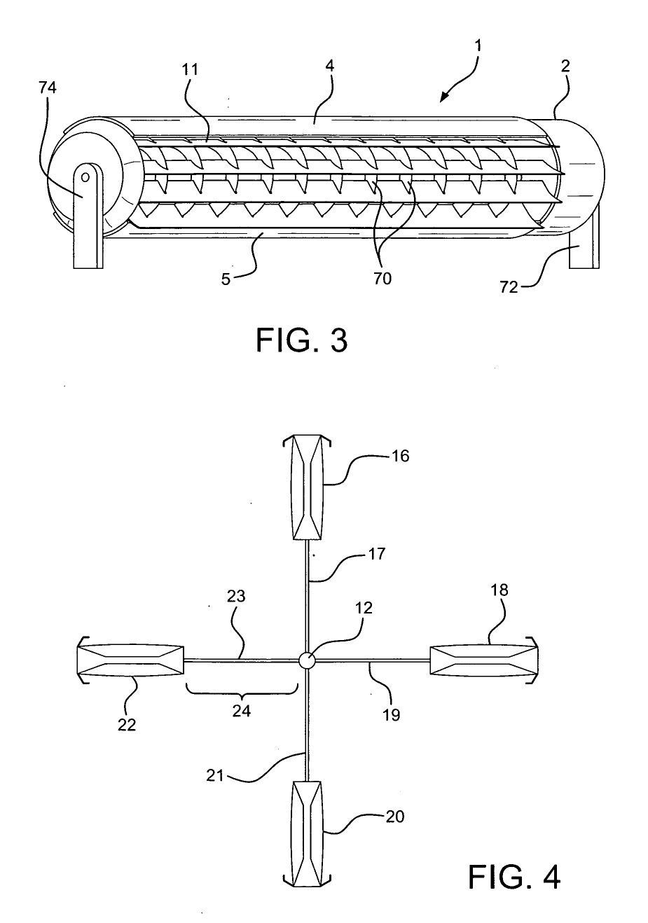

Vertically oriented fins 70 are optionally included, as shown in FIG. 3, to reduce turbulence and improve utilization of the incident air flow through housing 2. Housing support roof brackets 72 and 74 are provided to mount housing 2 to a roof or other high surface.

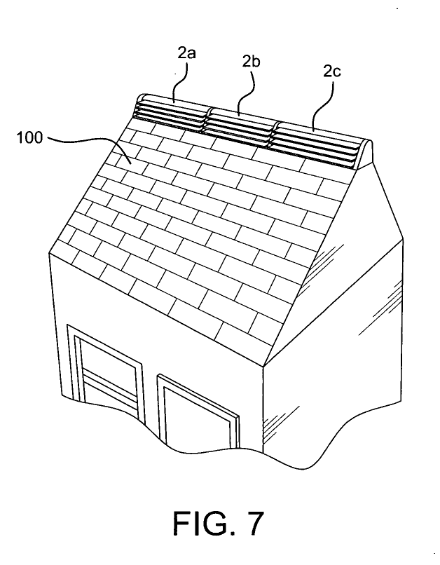

Housing 2 itself can readily be mounted to roof 100 of a building, house or like structure, as shown in FIG. 7. Several housings 2a, 2b, and 2c can be aligned in tandem on a roof surface for optimal wind power generation. Housing 2 can also be mounted in a vertical orientation on a stationary building or structure or configured for use on a spar or mast of a sailboat to provide power to the vessel.

The wind turbine of the present invention is a hybrid utilizing both drag and lift techniques. The wind turbine unit is provided in a compact, simple, and environmentally acceptable housing. It is thus able to be used in locations where wind generation would not otherwise be feasible due to regulatory requirements and other restrictions. The design has few moving parts, and its rotor unit design and its blades do not have to be produced in exacting standards or by use of expensive materials. Housing 2 protects the rotor unit 10 from weathering and ensures that it is safely contained and protected against inadvertent damage by humans, damage caused by animals or birds, and weather. Housing 2 also mitigates visual and noise problems associated with moving components.

Although four blades are shown in wind turbine 1, advantageous results can be achieved by use of between three and eight blades. The blades themselves may be formed from a wide variety of materials and processes, including extrusion and molding from metal, plastics, composites (e.g. fiberglass, carbon fiber) etc. The blades curl so it can be arranged to spiral along the length of the rotor unit to provide improved balance.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A wind driven turbine comprising:
a horizontally oriented rotor shaft having a horizontal axis;
inlet means for the entry of air flow;
outlet means for the discharge of air flow;
a plurality of elongated double sided rotating blades, each blade having an interior edge and an outer edge, the blades being connected and oriented perpendicular to the shaft, such that an elongated space is created between the interior edge of each blade and the shaft;
louver means for directionally and angularly controlling air flow towards the blades to rotate the blades and away from the blades to decrease turbulent air flow; and
shroud means for the containment of air flow between the outer edge of the blades and the shroud means, said shroud means being located above and below and extending substantially the length of the blades, whereby air flow between the outer edges of the blades and the shroud means provides a Venturi effect which enhances blade rotation and blade lift.

2. The wind driven turbine as in claim 1 wherein each blade comprises a concave lateral surface on each side of the blade.

3. The wind driven turbine as in claim 1 wherein the shroud means comprises an upper shroud member and a lower shroud member.

4. The wind driven turbine as in claim 1 wherein the louver means are electro-mechanically or mechanically moveable to control their angular orientation.

5. The wind driven turbine as in claim 1 further comprising end sections to which the shaft is mounted.

6. The wind driven turbine as in claim 1 wherein the louver means are located over the inlet and outlet means.

7. The wind driven turbine as in claim 1 further comprising fin means located substantially parallel to the blades to reduce turbulence and improve utilization of wind flow.

8. The wind driven turbine as in claim 1 further comprising blade tip means to reduce spillage of wind flow off the ends of the blades.

9. The wind driven turbine as in claim 1 wherein the blades are oriented parallel to the horizontal axis of the shaft.

10. The wind driven turbine as in claim 1 wherein the louver means are oriented parallel to the horizontal axis of the shaft.

11. The wind driven turbine as in claim 1 wherein the shaft is connected to an electric generator.

12. The wind driven turbine as in claim 5 wherein the turbine is mounted to the roof of a building structure.
